(19) United States
(12) Patent Application Publication
(10) Pub. No.: US 2011/0015063 A1
(43) Pub. Date: Jan. 20, 2011

(54) Multiple Component Materials Having A Color-Changing Composition

(76) Inventors: JunMo Gil, YuSung-gu (KR); Xuedong Song, Alpharetta, GA (US)

Correspondence Address: KIMBERLY-CLARK WORLDWIDE, INC.;Tara Pohlkotte, 2300 Winchester Rd., NEENAH, WI, 54956, US

(21) Appl. No.: 12/503,380

(22) Filed: Jul. 15, 2009

(51) Int. Cl. B01J 20/26; G01N 31/22; B05D 3/02

(52) U.S. Cl. 502/402; 252/408.1; 427/385.5

(57) ABSTRACT

The present invention relates to a multiple-component material including a substrate and a film layer on the substrate. The film layer includes a color-changing composition to indicate a change in condition, such as a change in pH. The color-changing composition includes a water-insoluble, film-forming polymer, a charged surfactant, a charged colorant and a pH adjuster.

### FIELD OF THE INVENTION

The present invention relates to multiple-component materials that include a substrate and a film layer formed on the substrate. The film layer includes a color-changing composition. The color-changing composition can cause the film layer to change in appearance of its color when the film layer is exposed to a change in physical or chemical environment. For example, the film layer may be on a nonwoven material that is used as a component of an absorbent article. The color-changing composition may include a pH indicator that changes color in response to the presence of urine.

### BACKGROUND OF THE INVENTION

Many products, including consumer and professional products, are more effectively used by an end user when they include a feature that indicates a particular condition or degree of use. An example of a visual indicator is a color indicator. Color indicators can either indicate a change in condition or a degree of use through a change from “no color” to “color” (or vice versa) or through a change from one color to a different color.

Exemplary conditions that could be monitored using a color indicator include physical conditions such as the presence of moisture and chemical conditions such as a change in pH. Exemplary consumer products that could be more effective and deliver more benefits to end users by incorporating a suitable color indicator include absorbent articles, facial tissues, bath tissue, paper towels, household cleaning items and personal cleaning wipes. Exemplary professional products that could be more effective and deliver more benefits to end users by incorporating a suitable color indicator include products for medical use, safety garments, industrial cleaning products and nonwoven materials.

Color indicators are well known and are available in various forms. Desirable performance attributes include durability and good retention (i.e. the color indicator remains where intended and does not leach out into other components of the product within which it is being used). Depending on the product application, it may also be desirable to have the structure in which the color indicator is used be wettable, but water insoluble. For purposes of applying the color indicator to a component of a product, it may also be desirable to have a color indicator that can be applied in liquid form at room temperature. When the color indicator is in a liquid form at room temperature, the color indicator can be printed (just like an ink composition) onto the desired component of a product.

Examples of how color indicators are already incorporated into consumer products include diapers that have wetness sensors. Some of the wetness sensors used in diapers change color to indicate wetness while others lose color in response to wetness (i.e. the color fades or disappears when it is dissolved by water). The concept of incorporating a color-changing composition into a wearable article (such as a disposable diaper) is known in the art. For example, U.S. Pat. No. 7,159,532 issued to Klofta et al. (hereinafter “the '532 patent”) is directed to wetness indicating compositions having improved colorant retention and durability for use with wearable articles. The wetness indicating compositions of the '532 patent have a first binding agent and a second binding agent. The first binding agent immobilizes a colorant when the colorant is in its initial color state and the second binding agent immobilizes the colorant when the colorant is in its final color state. The component materials used in the examples provided in the '532 patent are solid at room temperature as indicated by the description that they need to be melted in order to combine them. While the wetness indicating compositions of the '532 patent are capable of changing color in response to a stimulus, they are not capable of being applied to an article in liquid form at room temperature.

While the color-changing compositions known in the art provide certain benefits, there remains a need for a film-forming composition that can be applied to a substrate. There also remains a need for a composition that is durable, has good retention and that shows rapid and dramatic color change when the composition is used in a product. When the purpose of the composition is to detect the presence of wetness, there remains a need for a composition that is water-resistant and water-insoluble. Further, there remains a need for a composition that can be applied, such as by printing, at room temperature so that the composition can be applied to a substrate without heating.

### SUMMARY OF THE INVENTION

The present invention is directed to a multiple-component material that includes a film layer formed on a substrate. The film layer includes a color-changing composition that changes color when a change in physical or chemical condition is detected. The multiple-component materials of the invention may be used in personal care articles, such as the outer cover component of a disposable diaper. The color-changing composition includes a water-insoluble, film-forming polymer, a charged surfactant, a charged colorant and a pH adjuster. The charged colorant can be a pH indicator capable of changing color in response to the presence of a fluid. When the multiple-component material is used as part of the outer cover component of a disposable diaper, the charged colorant is in contact with the absorbent core of the diaper where fluid is stored during use. The color-changing composition is fluid at room temperature and may be applied as an ink would be applied to the substrate, such as by printing, spraying or stamping. The color-changing composition may be dissolved in an organic solvent that acts as a carrier and later evaporates after the color-changing composition is applied to the film layer or forms the film layer itself.

The water-insoluble, film-forming polymer may be selected from acrylate/acrylamide copolymers, polyurethane adhesives, and copolymers of vinylpyrrolidone and dimethylaminopropyl methacrylamide. Benefits of the color-changing composition including a film-forming polymer include that the composition adheres effectively to the substrate which prevents the composition from cracking off of the substrate when the composition is dry. When the multi-component material is used as part of the outer cover component of a disposable diaper, the film layer may have a barrier effect and may contribute to keeping fluid contained within the absorbent core of the diaper. The charge surfactant increases the wettability of the color-changing composition and helps reduce the leaching of the oppositely charged colorant. The charged colorant may be a pH indicator where the pH indicator is selected from bromocresol green, bromophenol blue and bromochlorophenol blue. The charged colorant may be selected so that it responds by changing color to a particular physical or chemical condition. Because the charged colorant is bound to the charged surfactant, the charged colorant is stabilized and is less likely to leach away from the color-changing composition. The color-changing composition may include one or more charged colorants. When more than one charged colorant is used, the charged colorants may be selected based on the desired effect (e.g. different color, better visibility, etc.). The color-changing composition may also include a base material. Suitable base materials include varnish bases.

Depending on the type of product that the multiple-component material is incorporated into, the film layer may be uniform across the substrate or the film layer may be formed in a pattern. If the color-changing composition is incorporated into an existing film layer, the color-changing composition may be applied uniformly or it may be applied in a pattern. Whether formed by the color-changing compositions of the inventions or whether formed by another material, the film layer may be formed on the substrate in one or more patterns selected from stripes, dots, geometric shapes, irregular shapes, alpha-numeric characters, anthropomorphic images, pictorial representation of animals, pictorial representation of inanimate objects, cartoon characters, logos and trademarks.

In another aspect, the present invention is directed to a multiple-component material that includes a substrate and a film layer on the substrate. The film layer includes a color-changing composition that includes 20% to 95% of a water-insoluble, film-forming polymer; 2% to 50% of a charged surfactant; 0.1% to 10% of a charged colorant; and 0.1% to 20% of a pH adjuster. Similarly, in another aspect, the present invention is directed to a disposable absorbent article including a multiple-component material. The multiple-component material includes a substrate and a film layer on the substrate. The film layer includes a color-changing composition that includes 60% to 90% of a water-insoluble, film-forming polymer; 10% to 30% of a charged surfactant; 1% to 5% of a charged colorant; and 0.5% to 5% of a pH adjuster.

In a different aspect, the present invention is directed to a method of forming a multiple-component material. The method includes a step of mixing the components of a color-changing composition with an organic solvent to form a mixture. The color-changing composition includes a water-insoluble, film-forming polymer; a charged surfactant; a charged colorant; and a pH adjuster. The method also includes a step of applying the mixture to a substrate. After the applying step, the method includes a step of allowing the mixture to dry; during this step of allowing the mixture to dry, the organic solvent evaporates and the color-changing composition of the mixture forms a film on the substrate. Therefore, the presence of the organic solvent is to facilitate the step of applying the mixture to a substrate. The organic solvent does not remain with the color-changing composition after the mixture dries as a film on the substrate. The method of the invention is more efficient and lower cost than known methods because the mixture can be applied to the substrate at room temperature and without heating because the mixture is liquid at room temperature.

These aspects and additional aspects of the invention will be described in greater detail herein. Further, it is to be understood that both the foregoing general description and the following detailed description are exemplary and are intended to provide further explanation of the invention claimed.

### DETAILED DESCRIPTION OF THE INVENTION

The present disclosure of the invention will be expressed in terms of its various components, elements, constructions, configurations, arrangements and other features that may also be individually or collectively be referenced by the term, “embodiment(s)” of the invention, or other similar terms. It is contemplated that the various forms of the disclosed invention may incorporate one or more of its various features and embodiments, and that such features and embodiments may be employed in any desired, operative combination thereof.

It should also be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

The present invention relates to multiple-component materials that include a color-changing composition. Unlike prior art color-changing compositions, the color-changing compositions of the present invention are fluid at room temperature and can be applied to a substrate without heating. For example, the color-changing composition may be printed like an ink onto a substrate at room temperature. This feature of the color-changing compositions makes them easier to handle during the manufacture of the articles to which they are applied. Further, the color-changing compositions of the present invention form a film when they are applied, such as by printing, to a substrate and dried. A benefit of the color-changing composition forming a film on the substrate is to afford good adherence and to prevent cracking.

The color-changing compositions of the invention may include an organic solvent as a vehicle for the compositions to be applied to a substrate where the organic solvent evaporates after application. When in the form of a film layer on a substrate, the color-changing compositions of the invention are wettable but insoluble in water. This feature makes the color-changing compositions desirable for use in articles where the compositions will be exposed to wetness. The feature also results in color-changing compositions that are durable and that are resistant to leaching out of the film layer. The film layer may be formed on the substrate in a desired pattern including stripes, dots, geometric shapes and irregular shapes and combinations of such pattern elements. The film layer may also be formed on the substrate as an alpha-numeric character, an anthropomorphic image, a pictorial representation of an animal, a pictorial representation of an inanimate object, a cartoon character, a product or company logo and a trademark or brand or combinations of such pictorial elements.

The present invention is directed to a multiple-component material that includes a substrate and a film layer. The substrate may be in the form of a porous foam, a reticulated foam, cellulose tissues, a plastic film, a woven material or a nonwoven material. Suitable plastic films that may be used to form the substrate include polyethylene films and polypropylene films. Suitable woven materials include woven materials made from natural fibers, synthetic fibers or combinations of natural and synthetic fibers. Natural fibers include cotton, silk and wool fibers and synthetic fibers include polyester, polyethylene and polypropylene fibers. Suitable nonwoven materials include nonwoven materials made through traditional techniques such as spunbond, meltblown and bonded carded web materials. The spunbond, meltblown and bonded carded web materials may be made from suitable synthetic fibers such as polyester, polyethylene and polypropylene fibers. The substrate may include combinations of the materials identified above such as a substrate that includes both a porous foam and a nonwoven material or a substrate that includes both a plastic film and a nonwoven material.

The multiple-component materials of the invention also include a film layer that is adhered to the substrate. The film layer includes a color-changing composition. The color-changing composition includes a water-insoluble, film-forming polymer. The film layer may be formed by the color-changing composition itself or the color-changing composition may be applied to or incorporated into the film layer. Because the color-changing compositions of the invention are fluid at room temperature, they can be applied through printing or stamping either directly onto the substrate (thereby self-forming the film layer) or onto a pre-existing film layer associated with the substrate.

The color-changing composition includes a water-insoluble, film-forming polymer. The water-insoluble, film-forming polymer is solid at room temperature, but soluble in a volatile organic solvent or an organic mixing solvent so that the color-changing composition is liquid at room temperature. Desirably, the water-insoluble polymers/copolymers have a substantial amount, greater than about 0.5% by weight, of polar atoms such as oxygen and nitrogen. The polar atoms may be present in polar functional groups such as amides, carboxylic acids and esters. Preferably, the water-insoluble polymers/copolymers are soluble in a volatile organic solvent such as ethanol, acetone, methanol, acetonitrile, tetrahydrofuran, benzene, toluene and mixtures of such solvents. The water-insoluble, film-forming polymer and the other components of the color-changing composition can be dissolved in the organic solvent prior to application onto the substrate. When the mixture of the color-changing composition and the organic solvent is formed, the mixture is liquid at room temperature. The volatile organic solvent evaporates when the color-changing composition is either applied to the film layer or forms the film layer. Suitable water-insoluble, film-forming polymers include acrylate/acrylamide copolymers, polyurethane adhesives, copolymers of vinylpyrrolidone and copolymers of dimethyl aminopropyl methacrylamide. Commercially-available suitable polymers include DERMACRYL 79 polymer and AMPHOMER HC polymer, both of which are acrylate/octylacrylamide copolymers available from Akzo Nobel. Another example of a commercially-available suitable polymer is GANTREZ SP polymer, which is a monoalkyl ester of poly(methyl vinyl ether/maleic acid) copolymer available from International Specialty Products Inc. The color-changing compositions of the invention include a water-insoluble, film-forming polymer in an amount of from 20% to 95% of the total weight of the color-changing composition. Desirably, the color-changing compositions of the invention include a water-insoluble, film-forming polymer in an amount of from 60% to 90% of the total weight of the color-changing composition.

The color-changing composition of the invention also includes a charged surfactant that may be positively or negatively charged. The charged surfactant may be a small molecule or a polymer. Suitable positively charged surfactants include benzathonium chloride and benzethonium chloride. Mixtures of positively charged surfactants may also be used. Suitable negatively charged surfactants include alkyl sulfates such as sodium laurylsulfate, sodium dodecylsulfate and sodium tetradodecyl sulfate. Alkylbenenesulfates such as sodium dodecylbenzenesulfonate and sodium diheptylsulocuccinate are also suitable negatively charged surfactants. Mixtures of negatively charged surfactants may also be used. The color-changing compositions of the invention include charged surfactants in an amount of from 2% to 50% of the total weight of the color-changing composition. Desirably, the color-changing compositions of the invention include charged surfactants in an amount of from 10% to 30% of the total weight of the color-changing composition.

The color-changing composition of the invention also preferably includes a charged colorant that functionally acts as a pH indicator. The charged colorant may be a neutral pH indicator, a charged pH indicator or a zwitterionic pH indicator. The charged colorant desirably changes color at either a pH greater than 9.5 or a pH lower than 5.5. The color change may be from color to colorless, colorless to color or from one color to another color. The charged colorant has the charged functional groups either in the core chromophore structure or derivatized in pendent groups. The charged colorant may be derivatized as a polymer. Examples of suitable charged colorants include the following: gentian violet (methyl violet), leucomalachite green, methyl yellow, bromophenol blue, Congo red, methyl orange, malachite green, brillian green, crystal violet, erythrosin B, methyl green, methyl violet 2B, picric acid, napthol yellow S, quinaldine red, Eosin Y, basic fuchsin, 4-(p-anilinophenylazo)benzene-sulfonic acid, sodium salt, phloxine B, bromochlorophenol blue W.S., ethyl orange, bromocresol nile blue A, thymolphthalein, aniline blue W.S., alizarin yellow GG, morgant orange I, tropaeolin O, orange G, acid fuchsin, thiazol yellow G, indigo carmine, phenolphthalein, thymolphthalein, alizarine yellow R, bromocresol green and their respective derivatives. The color-changing compositions of the invention include a charged colorant in an amount of from 0.1% to 10% of the total weight of the color-changing composition. Desirably, the color-changing compositions of the invention include a charged colorant in an amount of from 1% to 5% of the total weight of the color-changing composition. The color-changing compositions of the invention may include more than one charged colorant. One or more charged colorants that have visually different colors may be combined or charged colorants having the same visual color may be combined.

In addition to the other components, the color-changing composition includes a pH adjuster. The pH adjuster is any molecule or composition that may be used to control the pH of the color-changing composition. The pH adjuster may be an acid, a base or a combination of both such as would be found with a buffering composition. The pH adjuster is selected in conjunction with the choice of charged colorant to be used in the color-changing composition. For example, if the color-changing composition includes a charged colorant that has a color transition point that occurs at a pH of lower than 5.5, the selected pH adjuster is desirably an acid to make the pH of the color-changing composition acidic. If the color-changing composition includes a charged colorant that transitions color at a pH higher than 9.5, the selected pH adjuster is desirably a base to make the pH of the color-changing composition basic. Examples of suitable acid pH adjusters include organic acids, inorganic acids and polymeric acids; more specifically, examples include citric acid, oxalic acid, tartaric acid, salicylic acid, palmitic acid and stearic acid. Examples of suitable base pH adjusters include organic bases, inorganic bases and polymeric bases; more specifically, examples include sodium hydroxide, sodium carbonate, sodium bicarbonate, sodium borate, potassium hydroxide, polymeric amines, dendrimeric amine and 1,3-pentanediamine. Combination pH adjusters that have a buffering effect include acetic buffer, borate buffer and carbonate buffer. Desirably, the pH of the combination pH adjuster is either greater than 10 or lower than 5. Typically, the combination pH adjuster is in solution form and the concentration of the buffer may range from about 0.01 milliMolar to about 1000 milliMolar and desirably range from about 1 milliMolar to about 20 milliMolar, depending on the combination pH adjuster selected. The color-changing compositions of the invention include a pH adjuster in an amount of from 0.1% to 20% of the total weight of the color-changing composition. Desirably, the color-changing compositions of the invention include a pH adjuster in an amount of from 0.5 to 5% of the total weight of the color-changing composition.

Benefits of the pH adjuster include stabilizing the charged colorant against premature color changes that may be caused by exposure to humid environments. For example, the pH adjuster is believed to maintain a stable pH, such as a low pH environment with an acidic pH adjuster, around the charged colorant even when the film layer is exposed to high humidities.

The color-changing composition of the invention may also include a base material. The base material may be a small molecule, a polymeric material or a mixture of small molecules and polymers. Examples of suitable small molecule base materials include glycols, including triglycerols and their derivatives. Examples of suitable polymeric materials that may be used as base materials include polyvinyl alcohol, polyvinyl pyrrolidone, polyethylene glycol, water-soluble derivatives of polyacrylates and polyacrylamides, poly(hydroxyethyl methacrylates), poly(hydroxylethyl acrylates), carboxymethyl cellulose, gelatin and gum Arabic. Another suitable base material for the color-changing compositions of the invention is a varnish base such as a nitrocellulose compound based varnish or a phenolic-modified co-solvent-type polyamide resin-based varnish. The color-changing compositions of the invention may include a base material in an amount of from 20% to 95% of the total weight of the color-changing composition. It is believed that the base material may help the stability of the color-changing composition. It is also believed that the base material may improve the adhesion of the color-changing composition to the substrate of the multiple-component material. The base material may be water-soluble or water-insoluble.

When the components of the color-changing composition are formed as a film layer on the substrate, they must first be dissolved or suspended in an organic solvent that later evaporates. The result of the color-changing composition forming a film layer on the substrate is the multiple-component material of the invention. The organic solvent may be a single solvent or a mixture of solvents. Suitable solvents to carry the color-changing composition include ethanol, isopropanol, acetone, methanol, acetonitrile, tetrahydrofuran, benzene and toluene. An example of a useful application of the present invention is to apply the color-changing composition to a nonwoven substrate that is used as a component of a disposable absorbent article. More specifically, the nonwoven substrate may be a spunbond or other nonwoven material that is used to form the outer cover of a disposable diaper. The substrate may also be a polyethylene film that is adhered to a nonwoven material to form the outer cover of a disposable diaper. The film layer of the present invention may be formed on a nonwoven substrate or on another film. Because the color-changing compositions of the present invention are fluid at room temperature, they can be easily applied through printing to a substrate. Because the outer cover of an absorbent article, such as a disposable diaper, is typically adjacent the absorbent structure of the article, the color-changing composition is applied to a component that is in proximity to the absorbent structure when the finished product is in use. Therefore, the color-changing composition can be used to indicate a change in condition of the absorbent structure, such as wetness.

An example of a color-changing composition of the invention is a composition that includes an acrylate and octylacrylamide copolymer system as the water-insoluble, film-forming polymer; this polymer can assist adhesion of the charged colorant to the substrate and provide wettability with water resistance. Another example of the color-changing composition of the invention is a composition that includes a polyurethane adhesive with amide functionality as the water-insoluble, film-forming polymer. This water-insoluble, film-forming polymer can be dissolved in an alcohol for application to the substrate (with the alcohol subsequently evaporating). The color-changing compositions of the invention are water-wettable to allow rapid color change of the charged colorant component, but are water-insoluble to prevent leaching of the charged colorant. These are desirable performance attributes. In order to prepare the color-changing compositions of the invention, the water-insoluble particle is mixed with an oppositely-charged charged colorant and a pH adjuster.

The following are various examples that illustrate aspects of the present invention:

### EXAMPLE 1

### Preparation of Exemplary Color-Changing Composition #1:

The color-changing composition includes a water-insoluble, film-forming polymer of GANTREZ SP-125 polymer (available from International Specialty Products Inc.) in an amount of 50 mg/ml. The composition also includes a charged surfactant of benzathonium chloride in an amount of 20 mg/ml and a charged colorant of bromocresol green in an amount of 1.5 mg/ml. The composition includes a pH adjuster of citric acid in an amount of 7.5 mg/ml. When the components of the color-changing composition are combined together, they are dissolved in an organic solvent of isopropanol.

### EXAMPLE 2

### Preparation of Exemplary Color-Changing Composition #2:

The color-changing composition includes a water-insoluble, film-forming polymer of DERMACRYL 79 polymer (available from Akzo Nobel) in an amount of 100 mg/ml. The composition also includes a charged surfactant of benzethonium chloride in an amount of 100 mg/ml and a charged colorant of bromocresol green in an amount of 10 mg/ml. The composition includes a pH adjuster of citric acid in an amount of 35 mg/ml. When the components of the color-changing composition are combined together, they are dissolved in an organic solvent of ethanol.

### EXAMPLE 3

### Preparation of Exemplary Multiple Component Material #1:

Either Exemplary Color-Changing Composition #1 or Exemplary Color-Changing Composition #2 may be used to form the multiple component material. The Composition is applied (by either spraying, brushing or stamping) on a polyethylene film and is allowed to air-dry (during the drying process the organic solvent evaporates). The dried Composition forms a thin film that appears yellow or yellowish-green in color. A drop of fluid (either water, synthetic urine or urine) is applied to the multiple component material (i.e. the combination of the film layer on the polyethylene film). The film layer visibly changes color from yellow/yellowish-green to blue.

### EXAMPLE 4

### Preparation of Exemplary Multiple Component Material #2:

Either Exemplary Color-Changing Composition #1 or Exemplary Color-Changing Composition #2 may be used to form the multiple component material. The Composition is brushed onto a sheet of polypropylene film and is allowed to air-dry (during the drying process the organic solvent evaporates). The dried Composition forms a thin film that appears yellow or yellowish-green in color. The multiple component material (i.e. the combination of the film layer on the polypropylene film) is used to replace the outer cover material on a disposable diaper such that the multiple component material is in physical contact with the superabsorbent core of the diaper. The superabsorbent core is loaded with 10 ml of fluid (either water, synthetic urine or urine). The film layer of the multiple component material visibly changes color from yellow/yellowish-green to blue after a few minutes.

### EXAMPLE 5

### Preparation of Exemplary Multiple Component Material #3:

Either Exemplary Color-Changing Composition #1 or Exemplary Color-Changing Composition #2 may be used to form the multiple component material. The Composition is sprayed, brushed or stamped onto a sheet of tissue paper and is allowed to air-dry (during the drying process the organic solvent evaporates). The dried Composition forms a thin film that appears yellow or yellowish-green in color. A drop of fluid (either water, synthetic urine or urine) is applied to the multiple component material (i.e. the combination of the film layer on the tissue paper). The film layer visibly changes color from yellow/yellowish-green to blue.

### EXAMPLE 6

### Preparation of Exemplary Multiple Component Material #4:

A color-changing composition is prepared by combining 0.3 ml of 10% DERMACRYL 79 polymer solution in isopropyl alcohol (as the water-insoluble, film-forming polymer), 0.05 ml solution of diluted 3 wt % poly (Bis(2-chloroethyl)ether-alt-1,3-bis[3-(dimethylamino)propyl]-urea) solution in isopropyl alcohol and water (1/1 volume ratio) (as the charged surfactant) and 0.0369 grams citric acid (as the pH adjuster) were mixed by vortexing. Then, two charged colorants, bromocresol green 0.0022 g and methyl red 0.0052 g, were added and dissolved into the solution retaining some precipitate by full saturation of ingredients. The “upper” solution was used to form a film by spreading the solution on outer cover film from a HUGGIES disposable diaper; the film layer was allowed to dry. The color of the dry film layer was red and the color changed to dark blue when saline solution was applied to the film layer.

### EXAMPLE 7

### Preparation of Exemplary Multiple Component Material #5:

A color-changing composition is prepared by combining 0.3 ml of 10% DERMACRYL 79 polymer solution in isopropyl alcohol (as the water-insoluble, film-forming polymer), 0.05 ml solution of diluted 3 wt % poly (Bis(2-chloroethyl) ether-alt-1,3-bis[3-(dimethylamino)propyl]-urea) solution in isopropyl alcohol and water (1/1 volume ratio) (as the charged surfactant) and 0.0321 g citric acid (as the pH adjuster) were mixed by vortexing. Then, two charged colorants, bromocresol green 0.0026 g and methyl orange 0.0040 g, were added and dissolved into the solution retaining some precipitate by full saturation of ingredients. The “upper” solution was used to form a film by spreading the solution on outer cover film from a HUGGIES disposable diaper; the film layer was allowed to dry. The color of the dry film layer was orange and the color changed to greenish blue when saline solution was applied to the film layer.

### EXAMPLE 8

### Preparation of Exemplary Multiple Component Material #6:

A color-changing composition is prepared by combining 0.3 ml of 10% DERMACRYL 79 polymer solution in isopropyl alcohol (as the water-insoluble, film-forming polymer), 0.05 ml solution of diluted 3 wt % poly (Bis(2-chloroethyl) ether-alt-1,3-bis[3-(dimethylamino)propyl]-urea) solution in isopropyl alcohol and water (1/1 volume ratio) (as the charged surfactant) and 0.0679 g citric acid (as the pH adjuster) were mixed by vortexing. Then, two charged colorants, bromocresol green 0.0028 g and congo red 0.0046 g, were added and dissolved into the solution retaining some precipitate by full saturation of ingredients. The “upper” solution was used to form a film by spreading the solution on outer cover film from a HUGGIES disposable diaper; the film layer was allowed to dry. The color of the dry film layer was dark yellow and the color changed to yellowish blue when saline solution was applied to the film layer.

### EXAMPLE 9

### Preparation of Exemplary Multiple Component Material #7:

A color-changing composition is prepared by combining 0.3 ml of 10% DERMACRYL 79 polymer solution in isopropyl alcohol (as the water-insoluble, film-forming polymer), 0.05 ml solution of diluted 3 wt % poly (Bis(2-chloroethyl) ether-alt-1,3-bis[3-(dimethylamino)propyl]-urea) solution in isopropyl alcohol and water (1/1 volume ratio) (as the charged surfactant) and 0.0567 g citric acid (as the pH adjuster) were mixed by vortexing. Then, two charged colorants, bromocresol green 0.0039 g and allure red AR 0.0029 g, were added and dissolved into the solution retaining some precipitate by full saturation of ingredients. The “upper” solution was used to form a film by spreading the solution on outer cover film from a HUGGIES disposable diaper; the film layer was allowed to dry. The color of the dry film layer was light orange and the color changed to blue when saline solution was applied to the film layer.

While the multiple-component materials of the invention have been described in detail with respect to specific aspects thereof, it will be appreciated that those skilled in the art, upon attaining an understanding of the foregoing, may readily conceive of alterations to, variations of and equivalents to these materials. Accordingly, the scope of the present invention should be assessed as that of the appended claims and any equivalents thereto.

We claim:

1. A multiple-component material, the material comprising:
a substrate and a film layer on the substrate, wherein the film layer includes a color-changing composition, the color-changing composition comprising:
a water-insoluble, film-forming polymer;
a charged surfactant;
a charged colorant; and
a pH adjuster.

2. The multiple-component material of claim 1, wherein the water-insoluble, film-forming polymer has greater than about 0.5% by weight of polar atoms.

3. The multiple-component material of claim 1, wherein the water-insoluble, film-forming polymer is selected from acrylate/acrylamide copolymers, polyurethane adhesives, and copolymers of vinylpyrrolidone and dimethylaminopropyl methacrylamide.

4. The multiple-component material of claim 1, wherein the charged colorant is a pH indicator.

5. The multiple-component material of claim 4, wherein the pH indicator is selected from bromocresol green, bromophenol blue and bromochlorophenol blue, methyl orange, tetrabromophenol blue, ethyl orange, Congo red, methyl red and allure red AR.

6. The multiple-component material of claim 1, wherein the color-changing composition includes more than one charged colorant.

7. The multiple-component material of claim 1, wherein the substrate is a non-woven material.

8. The multiple-component material of claim 1, wherein the substrate is a polyolefin film.

9. The multiple-component material of claim 1, wherein the substrate is selected from a polyethylene film and a polypropylene film.

10. The multiple-component material of claim 1, wherein the color-changing composition further comprises a base material.

11. The multiple-component material of claim 10, wherein the base material is a varnish base.

12. A disposable absorbent article including the multiple-component material of claim 1 as part of an outer cover.

13. The multiple-component material of claim 1, wherein the film layer is formed on the substrate in one or more patterns selected from stripes, dots, geometric shapes, irregular shapes, alpha-numeric characters, anthropomorphic images, pictorial representation of animals, pictorial representation of inanimate objects, cartoon characters, logos and trademarks.

14. A multiple-component material, the material comprising:
a substrate and a film layer on the substrate, wherein the film layer includes a color-changing composition, the color-changing composition comprising:
20% to 95% of a water-insoluble, film-forming polymer;
2% to 50% of a charged surfactant;
0.1% to 10% of a charged colorant; and
0.1% to 20% of a pH adjuster.

15. A disposable absorbent article including a multiple-component material, the material comprising: a substrate and a film layer on the substrate, wherein the film layer includes a color-changing composition, the color-changing composition comprising:
20% to 95% of a water-insoluble, film-forming polymer;
2% to 50% of a charged surfactant;
0.1% to 10% of a charged colorant; and
0.1% to 20% of a pH adjuster.

16. A method of forming a multiple-component material, the method comprising the steps of:
mixing components of a color-changing composition with an organic solvent to form a mixture, wherein the components of the color-changing composition include a water-insoluble, film-forming polymer; a charged surfactant; a charged colorant; and a pH adjuster;
applying the mixture to a substrate; and
allowing the mixture to dry, wherein during this step the organic solvent evaporates and the color-changing composition of the mixture forms a film on the substrate.

17. The method of forming a multiple-component material of claim 16, wherein the mixture is liquid at room temperature.
